(19) United States
(12) Patent Application Publication
(10) Pub. No.: US 2007/0052844 A1
(43) Pub. Date: Mar. 8, 2007

(54) Information processing apparatus and computer program product

(75) Inventor: Kenryo Kanaya, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/513,193

(22) Filed: Aug. 31, 2006

(30) Foreign Application Priority Data
Aug. 31, 2005 (JP) 2005-252424

(51) Int. Cl. H04N 11/20

(52) U.S. Cl. 348/448

(57) ABSTRACT

According to one embodiment, there is provided an information processing apparatus that generates a progressive video signal including frames from an interlace video signal including pieces of field information in time sequence. The information processing apparatus includes: a video adjustment processing section that performs video adjustment processing to each of the pieces of field information; and an interlace-progressive conversion processing section that performs interpolation processing using at least three pieces of field information subjected to the video adjustment processing to generate each of the frames included in the progressive video signal.

### CROSS-REFERENCE TO RELATED APPLICATIONS

This application is based upon and claims the benefit of priority from Japanese Patent Application No. 2005-252424, filed Aug. 31, 2005, the entire contents of which are incorporated herein by reference.

### BACKGROUND

1. Field

One embodiment of the invention relates to an information processing apparatus such as a personal computer and a computer program product used with the apparatus.

2. Description of the Related Art

Generally, a video signal used for broadcast of a TV program, etc., is an interlace video signal as interlaced horizontal scanning from top to bottom. In contrast, a video signal used for display on a display monitor of a computer is a progressive video signal as sequential horizontal scanning from top to bottom. Thus, to display the video data of a TV broadcast program, etc., obtained through a TV tuner, etc., on a display of a computer, the interlace video signal needs to be converted into the progressive video signal. This conversion generally is called IP conversion (or progressive conversion). For example, Japanese Patent Application Publication (KOKAI) No. 2003-87797 discloses a technique for performing half thinning-out processing in a vertical direction in the IP conversion and selecting the later field in time sequence in the same frame at the time to prevent degradation of an image quality.

In the IP conversion, one frame image in the progressive video signal is generated by performing interpolation processing using a plurality of pieces of field information in time sequence in the interlace video signal. To generate one frame image, for example, three pieces of field information rather than two pieces are used so that a video signal of a high sampling frequency can be provided and the video image displayed on the display can be represented still more smoothly. Such IP conversion generally is called double framing. The double framing is important processing in a computer requiring the high image quality of video although it increases the computation processing amount.

To make it possible to appropriately display the video signal used for broadcast of a TV program, etc., on the display of the computer, it is necessary to perform scaling processing for converting the aspect ratio of video, resolution conversion processing for enhancing low resolution, brightness extension including black extension and white extension, etc., as well as the IP conversion (which will be hereinafter referred to as video adjustment processing).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view to show an outline of a computer according to one embodiment of the invention

FIG. 2 is an exemplary block diagram to show the system configuration of the computer in FIG. 1;

FIG. 3 is an exemplary block diagram to show a functional configuration of a TV application program used by the computer in FIG. 1;

FIG. 4 is an exemplary conceptual drawing to show a plurality of pieces of field information including an interlace video signal;

FIG. 5 is an exemplary block diagram to show a functional configuration of a pixel complementation module in FIG. 3;

FIG. 6 is an exemplary block diagram to show a functional configuration of a brightness extension module in FIG. 3;

FIG. 7 is an exemplary drawing to describe processing performed by a nonlinear scaling module and a resolution change module in FIG. 5;

FIG. 8 is a drawing to show a specific example of nonlinear scaling;

FIG. 9 is an exemplary drawing to show a basic IP conversion technique;

FIG. 10 is an exemplary drawing to show an IP conversion (double framing) technique in an IP conversion module; and

FIG. 11 is an exemplary flowchart to show the operation of image processing.

### DETAILED DESCRIPTION

Various embodiments according to the invention will be described hereinafter with reference to the accompanying drawings. In general, according to one embodiment of the invention, there is provided an information processing apparatus that generates a progressive video signal including frames from an interlace video signal including pieces of field information in time sequence. The information processing apparatus includes: a video adjustment processing section that performs video adjustment processing to each of the pieces of field information; and an interlace-progressive conversion processing section that performs interpolation processing using at least three pieces of field information subjected to the video adjustment processing to generate each of the frames included in the progressive video signal.

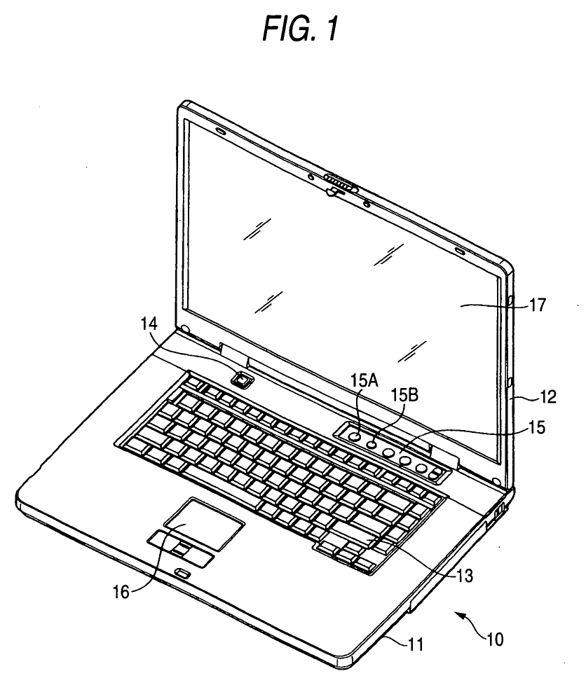

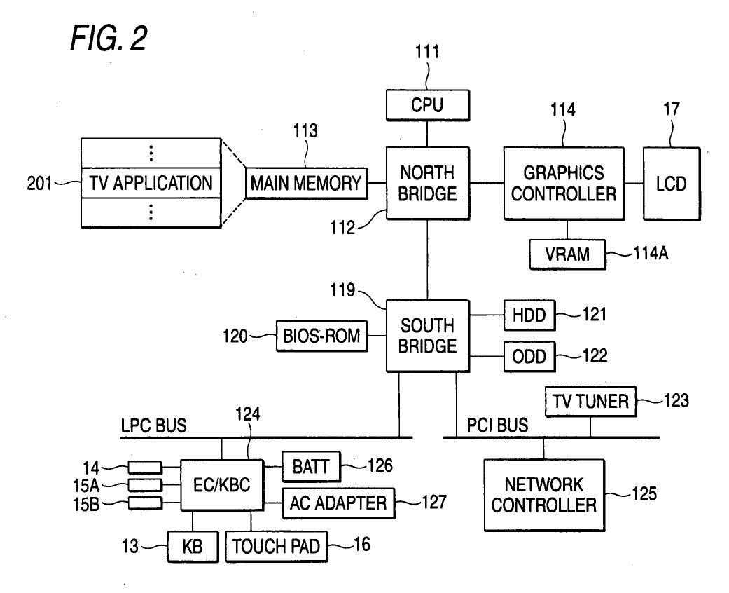

First, an exemplary configuration of an information processing apparatus according to one embodiment of the invention will be discussed with reference to FIGS. 1 and 2. The information processing apparatus is implemented as a notebook personal computer 10, for example.

FIG. 1 is an exemplary front view of the notebook personal computer 10 in a state in which a display unit is open. The computer 10 is made up of a computer main unit 11 and a display unit 12. A display implemented as a TFT-LCD (Thin Film Transistor Liquid Crystal Display) 17 is built in the display unit 12 and the display screen of the LCD 17 is positioned almost in the center of the display unit 12.

The display unit 12 is attached to the computer main unit 11 so that the display unit 12 is pivotable between an open position and a closed position. The computer main unit 11 has a thin box-shaped cabinet, and a keyboard 13, a power button 14 for turning on/off power of the computer 10, an input operation panel 15, a touch pad 16, and the like are placed on the top face of the cabinet.

The input operation panel 15 is an input unit for inputting an event corresponding to a pressed button, and includes a plurality of buttons for starting a plurality of functions. The buttons also include a TV start button 15A and a DVD/CD start button 15B. The TV start button 15A is a button for starting a TV function to play back, view, and record TV broadcast program data. When the user presses the TV start button 15A, a TV application program for executing the TV function is automatically started.

A suboperating system dedicated to processing of AV (audiovisual) data as well as a general-purpose main operating system is installed in the computer 10. The TV application program is a program operating in the suboperating system.

When the user presses the power button 14, the main operating system is started. When the user presses the TV start button 15A while the main operating system is started, the TV application program is executed. When the user presses the TV start button 15A while the main operating system is not started, the suboperating system rather than the main operating system is started and the TV application program is automatically executed. The suboperating system has only the minimum function for executing the AV function. Thus, the time required for boot-up of the suboperating system is far shorter that the time required for boot-up of the main operating system. Thus, the user can instantly view or record a TV program simply by pressing the TV start button 15A.

The DVD/CD start button 15B is a button switch for playing back video content recorded on a DVD or a CD. When the user presses the DVD/CD start button 15B, a video playback application program for playing back video content is automatically started. When the user presses the DVD/CD start button 15B, if the main operating system is started, the video playback application program on the main operating system is started. If the power is off, the suboperating system rather than the main operating system is started and the video playback application program is automatically executed.

Next, the system configuration of the computer 10 will be discussed with reference to FIG. 2.

The computer 10 includes a CPU 111, a north bridge 112, main memory 113, a graphics controller 114, a south bridge 119, BIOS-ROM 120, a hard disk drive (HDD) 121, an optical disk drive (ODD) 122, a TV tuner 123, an embedded controller/keyboard controller IC (EC/KBC) 124, a network controller 125, and the like, as shown in FIG. 2.

The CPU 111 is a processor provided for controlling the operation of the computer 10 and executes the main operating system, the suboperating system, and various application programs such as a TV application program 201 loaded into the main memory 113 from the hard disk drive (HDD) 121. The CPU 111 can execute a plurality of types of processing in parallel using a plurality of pipelines.

The TV application program 201 has a function of converting video data contained in the TV broadcast program data received by the TV tuner 123 into high image quality.

The CPU 111 also executes system BIOS (Basic Input Output Program) stored in the BIOS-ROM 120. The system BIOS is a hardware control program.

The north bridge 112 is a bridge device for connecting a local bus of the CPU 111 and the south bridge 119. The north bridge 112 also contains a memory controller for controlling access to the main memory 113. The north bridge 112 also has a function of executing communications with the graphics controller 114 through an AGP (Accelerated Graphics Port) bus, etc.

The graphics controller 114 is a display controller for controlling the LCD 17 use as the display monitor of the computer 10. The graphics controller 114 displays video data written into video memory (VRAM) 114A on the LCD 17.

The south bridge 119 controls devices on an LPC (Low Pin Count) bus and devices on a PCI (Peripheral Component Interconnect) bus. The south bridge 119 also contains an IDE (Integrated Drive Electronics) controller for controlling the HDD 121 and the ODD 122. Further, the south bridge 119 also has a function of controlling the TV tuner 123 and a function of controlling access to the BIOS-ROM 120.

The HDD 121 is a storage unit for storing various types of software and various pieces of data. The optical disk drive (ODD) 122 is a drive unit for driving storage media such as a DVD and a CD storing video content. The TV tuner 123 is a receiver for receiving external broadcast program data of TV broadcast programs, etc.

The embedded controller/keyboard controller IC (EC/KBC) 124 is a one-chip microcomputer into which an embedded controller for power management and a keyboard controller for controlling the keyboard (KB) 13 and the touch pad 16 are integrated. The embedded controller/keyboard controller IC (EC/KBC) 124 has a function of turning on/off the power of the computer 10 in response to user operation of the power button 14. The operation power supplied to the components of the computer 10 is generated from a battery 126 contained in the computer 10 or external power supplied through an AC adapter 127.

Further, the embedded controller/keyboard controller IC (EC/KBC) 124 can also turn on the power of the computer 10 in response to user operation of the TV start button 15A or the DVD/CD start button 15B. The network controller 125 is a communication unit for executing communications with an external network such as the Internet, for example.

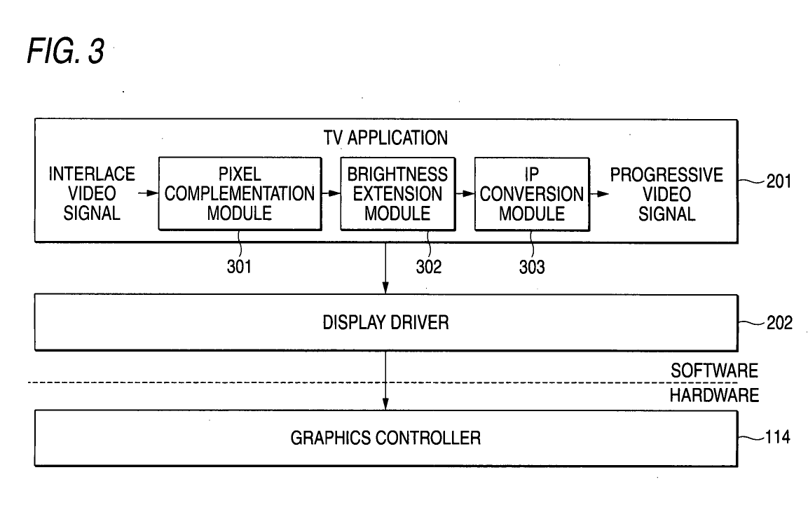

FIG. 3 is an exemplary block diagram to show a functional configuration of the TV application program 201 in FIG. 2.

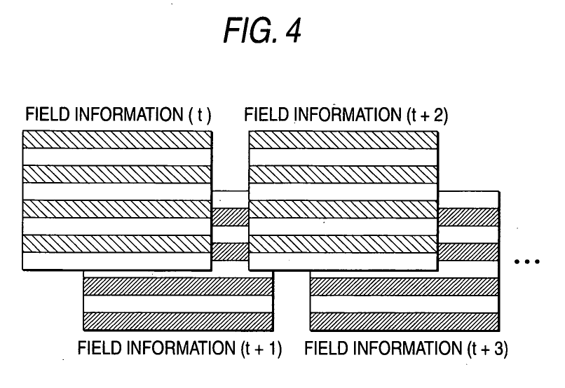

The TV application program 201 includes a pixel complementation module 301, a brightness extension module 302, an IP conversion module 303, etc., as video processing functions for converting video sent as a stream into high image quality. The TV application program 201 uses the modules to perform video adjustment processing of pixel complementation, brightness extension, etc., for interlace video signals with a plurality of pieces of field information as shown in FIG. 4 sequentially sent on the time series, and then performs interlace-progressive conversion (IP conversion) to generate a progressive video signal. That is, in the embodiment, the video adjustment processing of pixel complementation, brightness extension, etc., is performed before the IP conversion processing.

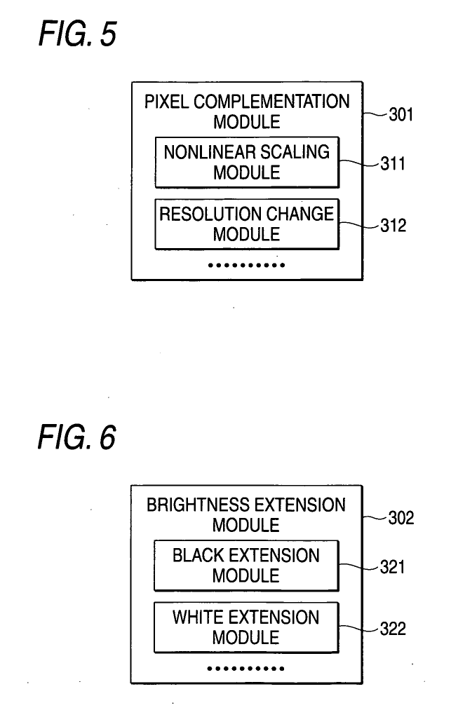

The pixel complementation module 301 executes pixel complementation processing (one of the video adjustment processing) of performing pixel complementation for each of pieces of field information provided in time sequence in the interlace video signal, and includes a nonlinear scaling module 311, a resolution change module 312, etc., as shown in FIG. 5. The nonlinear scaling module 311 executes nonlinear scaling processing that extends the field information so that extension ratio of the area width by performing pixel complementation from a center area to each end area for each piece of field information. The resolution change module 312 executes resolution change processing of enhancing the resolution by performing pixel complementation for each piece of field information.

The brightness extension module 302 executes brightness extension processing for adjusting brightness pixel by pixel for each piece of the field information subjected to the pixel complementation processing by the pixel complementation module 301, and includes a black extension module 321, a white extension module 322, etc., as shown in FIG. 6. The black extension module 321 executes gradation correction for enhancing the black tint to prevent occurrence of white spots, etc. The white extension module 322 executes gradation correction for enhancing the white tint to prevent occurrence of black crushing, etc. The modules can widen the dynamic range of video.

The IP conversion module 303 executes conversion processing from an interlace video signal to a progressive video signal; the IP conversion module 303 performs interpolation processing using at least three pieces of field information after subjected to the video adjustment processing through the pixel complementation module 301 and the brightness extension module 302 to generate each of the frames included in a progressive video signal (performs double framing).

The video data with high image quality provided by the TV application program 201 is written into the video memory 114A of the graphics controller 114 through a display driver 202, software for controlling the graphics controller 114.

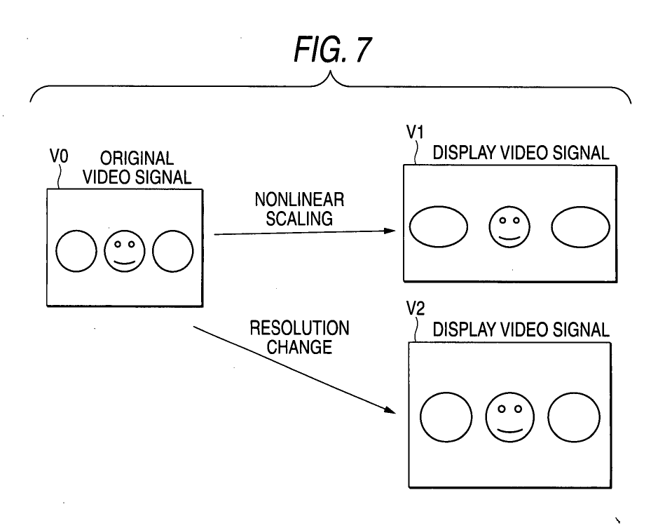

FIG. 7 is an exemplary drawing to describe processing performed by the nonlinear scaling module 311 and the resolution change module 312 included in the pixel complementation module 301.

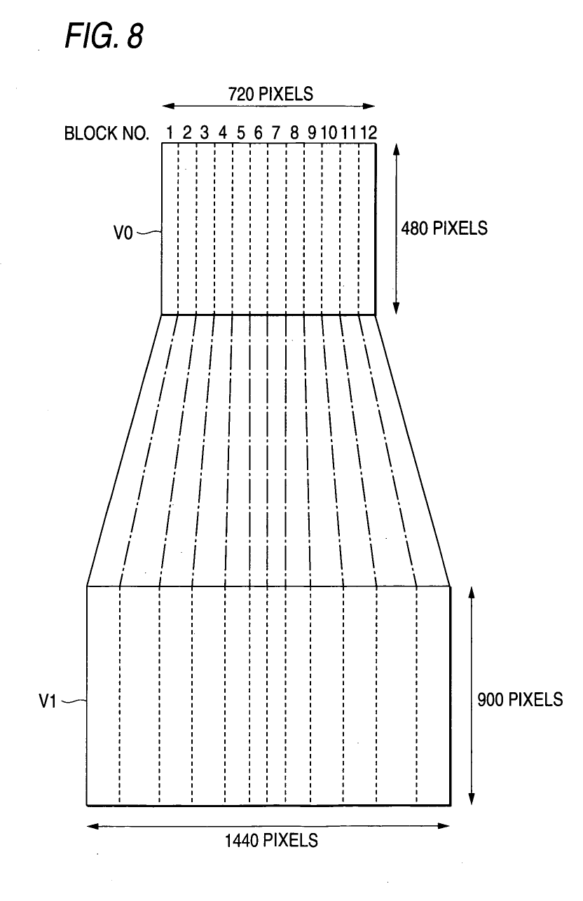

When the nonlinear scaling module 311 executes nonlinear scaling of converting an original signal V0 with an aspect ratio 4:3 into a display video signal V1 with the aspect ratio 16:9, for example, it is necessary to enlarge the image extension particularly in the horizontal direction. In this case, the extension ratio of the area width is increased toward each end area without extending the center portion in the video signal as shown in FIG. 7 so that a sense of incompatibility with the video extension given to the viewer can be decreased. Specifically, the original image signal V0 is divided into blocks and when each block is extended in the horizontal direction, the blocks are not extended at the same ratio and the extension ratio of the block width is increased toward each end area while the extension ratio of the block width at the center in the video signal is suppressed, as shown in FIG. 8. To extend the block width in such a manner, pixel complementation is performed.

The resolution change module 312 performs conversion processing from an original image signal V0 with comparatively low resolution to a display video signal V2 with comparatively high resolution. In the processing of enhancing the resolution in such a manner, pixel complementation is performed.

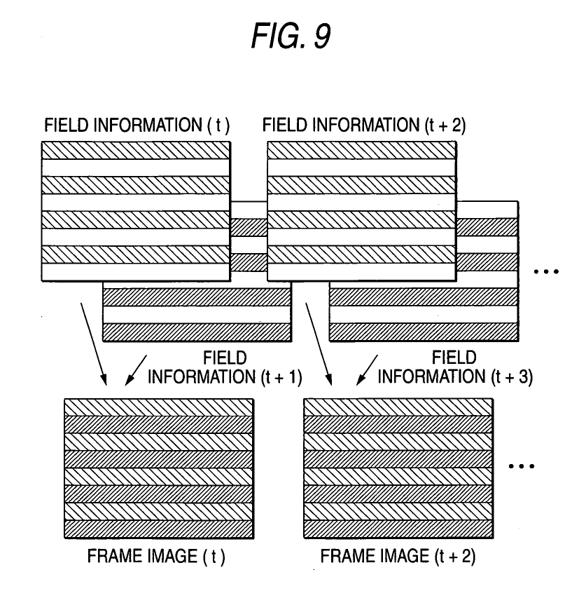

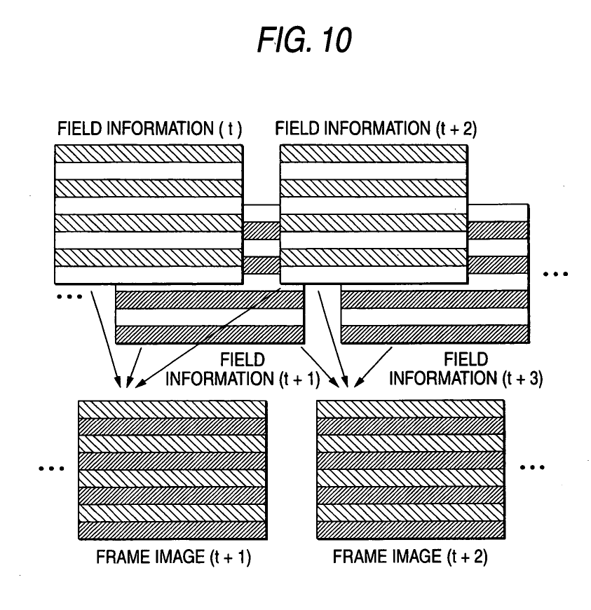

FIG. 9 is an exemplary drawing to show a basic IP conversion technique. FIG. 10 is an exemplary drawing to show the IP conversion (double framing) technique in the IP conversion module 303. In each figure, it is assumed that an interlace video signal includes field information (t), field information (t+1), field information (t+2), field information (t+3), . . . in time sequence and that 60 pieces of the field information are sent per second. In this case, the time interval between the adjacent field information pieces is 1/60 seconds.

In the basic IP conversion shown in FIG. 9, for example, a frame (t) at time t is obtained based on field information (t) at time t and field information (t+1) at time t+1. Likewise, a frame (t+2) at time t+2 is obtained based on field information (t+2) at time t+2 and field information (t+3) at time t+3. Consequently, a progressive video signal with a sampling frequency of 30 Hz is obtained.

In contrast, in the IP conversion shown in FIG. 10, for example, a frame (t+1) at time t+1 is obtained based on field information (t) at time t, field information (t+1) at time t+1, and field information (t+2) at time t+2. Likewise, a frame (t+1) at time t+1 is obtained based on field information (t+1) at time t+1, field information (t+2) at time t+2, and field information (t+3) at time t+3. Consequently, a progressive video signal with a sampling frequency of 60 Hz is obtained.

Thus, according to the IP conversion of the IP conversion module 303, the sampling frequency can be raised as compared with the basic IP conversion and thus smoothness of the image displayed on the display can be improved. Moreover, the video adjustment processing of pixel complementation, brightness extension, etc., is already complete before the IP conversion is executed, so that it is not necessary to perform such computation processing furthermore increasing the load on the CPU for the video signal output from the IP conversion module 303.

In this embodiment, the pixel complementation module 301, the nonlinear scaling module 311, the resolution change module 312, the brightness extension module 302, the black extension module 321, and the white extension module 322 serve as a video adjustment processing section. Also, in this embodiment, the IP conversion module 303 serves as an interlace-progressive conversion processing section.

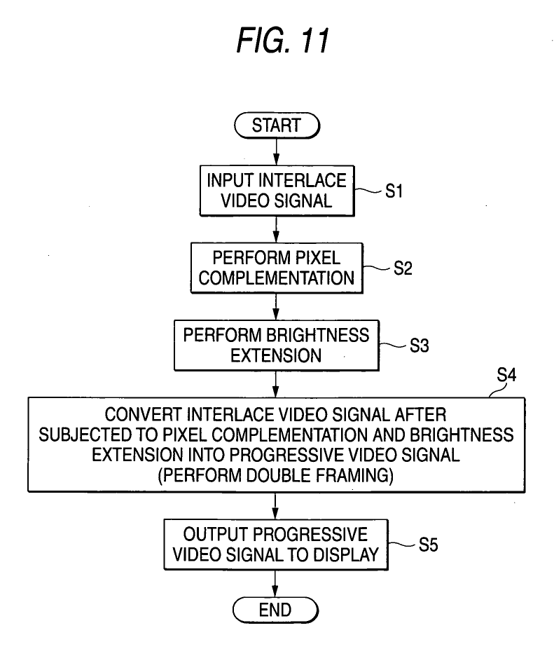

Next, the operation of the image processing in the embodiment will be discussed with reference to FIG. 11.

Upon reception of an interlace video signal (block S1), the TV application program 201 first performs pixel complementation processing (including nonlinear scaling processing, resolution conversion processing, etc.,) for pieces of field information provided in time sequence in the interlace video signal in the pixel complementation module 301 as the pixel complementation processing (block S2). In addition, the TV application program 201 performs brightness extension processing (including black extension processing, white extension processing, etc.,) for the pieces of field information in the brightness extension module 302 as the pixel complementation processing (block S3).

After performing such video adjustment processing, the TV application program 201 performs interpolation processing using at least three pieces of field information in the IP conversion module 303 to generate each frame as interlace to progressive conversion processing (double framing) (block S4).

Last, the TV application program 201 outputs the progressive video signal generated by the IP conversion module 303 to the display of the LCD 17, etc., through the driver, etc. (block S5).

Thus, according to the embodiment, the pixel complementation processing (nonlinear scaling processing, resolution conversion processing, etc.,) and the brightness extension processing (containing black extension processing, white extension processing, etc.,) are executed before the interlace to progressive conversion processing is performed, so that the computation processing amount involved in the processing can be reduced and while the load on the arithmetic unit such as the CPU is decreased, a high-quality video image can be generated.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus that generates a progressive video signal including frames from an interlace video signal including pieces of field information in time sequence, the information processing apparatus comprising:
a video adjustment processing section that performs video adjustment processing to each of the pieces of field information; and
an interlace-progressive conversion processing section that performs interpolation processing using at least three pieces of field information subjected to the video adjustment processing to generate each of the frames included in the progressive video signal.

2. The information processing apparatus according to claim 1, wherein the video adjustment processing includes pixel complementation processing that complements pixels for each of the pieces of field information.

3. The information processing apparatus according to claim 1, wherein the video adjustment processing includes nonlinear scaling processing that extends each of the pieces of field information so that an extension ratio of an area width increases from a center area to an end area for each of the pieces of field information.

4. The information processing apparatus according to claim 1, wherein the video adjustment processing includes resolution change processing that changes resolutions for each of the pieces of field information.

5. The information processing apparatus according to claim 1, wherein the video adjustment processing includes brightness extension processing that adjusts brightness of each pixel of each of the pieces of field information.

6. A computer program product for enabling a computer to generate a progressive video signal including frames from an interlace video signal including pieces of field information in time sequence, the computer program product comprising:
software instructions for enabling the computer to perform predetermined operations, and
a computer readable medium bearing the software instructions;
the predetermined operations including:
performing video adjustment processing to each of the pieces of field information; and
performing interpolation processing using at least three pieces of field information subjected to the video adjustment processing to generate each of the frames included in the progressive video signal.

7. The computer program product according to claim 6, wherein the video adjustment processing includes pixel complementation processing that complements pixels for each of the pieces of field information.

8. The computer program product according to claim 6, wherein the video adjustment processing includes nonlinear scaling processing that extends each of the pieces of field information so that an extension ratio of an area width increases from a center area to an end area for each of the pieces of field information.

9. The computer program product according to claim 6, wherein the video adjustment processing includes resolution change processing that changes resolutions for each of the pieces of field information.

10. The computer program product according to claim 6, wherein the video adjustment processing includes brightness extension processing that adjusts brightness of each pixel of each of the pieces of field information.
